(19) United States
(12) Patent Application Publication
(10) Pub. No.: US 2026/0058882 A1
(43) Pub. Date: Feb. 26, 2026

(54) COMMUNICATION METHOD AND APPARATUS

(71) Applicant: BEIJING XIAOMI MOBILE SOFTWARE CO., LTD., Beijing (CN)

(72) Inventor: Qin MU, Beijing (CN)

(21) Appl. No.: 19/102,682

(22) PCT Filed: Aug. 11, 2022
(86) PCT No.: PCT/CN2022/111907

§ 371 Date: Feb. 10, 2025

(51) Int. Cl. H04L 41/16; H04W 24/10

(52) U.S. Cl. CPC H04L 41/16; H04W 24/10

(57) ABSTRACT

A communication method, performed by a terminal, includes: monitoring an inference performance of an artificial intelligence (AI) model, in response to determining that air interface communication is performed between the terminal and a network device based on the AI model. Monitoring may be performed based on an inference result, or intermittently based on a time interval.

### CROSS-REFERENCE TO RELATED APPLICATIONS

This application is the US national phase application of International Application No. PCT/CN2022/111907 filed on Aug. 11, 2022, the entire contents of which are incorporated herein by reference.

### TECHNICAL FIELD

The present disclosure relates to the field of wireless communication technologies, and in particular to a communication method and apparatus.

### BACKGROUND

With development of communication technologies, widespread application of 5G wireless communication systems has brought huge changes to all aspects of people's lives. The 5G technologies will penetrate into all areas of future society and build a comprehensive information ecosystem centered on a user. A 5G user experience can reach a 100 Mbit/s˜1 Gbit/s data transfer rate, which can support ultimate experiences such as mobile virtual reality. A 5G peak rate can reach 10 Gbit/s˜20 Gbit/s, and a traffic density can reach 10 Mbit/s/m², which can support growth of mobile business traffic by more than a thousand times in the future. Further, 5G connection density can reach 1 million/m², which can effectively support a large number of IoT devices, a 5G transmission delay can reach an order of milliseconds, which can meet stringent requirements of Internet of Vehicles and industrial control, and 5G can support a mobile speed of 500 km/h which provides a good user experience in a high-speed rail environment. As a representative of new infrastructure, 5G will reshape the future information society.

In recent years, artificial intelligence (AI) technology has made continuous breakthroughs in many fields. The continuous development of intelligent voice, computer vision and other fields not only brings a variety of applications to an intelligent terminal, but is also widely used in education, transportation, home, medical, retail, security and other fields. These applications add convenience to people's lives, and also promote industrial upgrading in various industries. The AI technology is also accelerating its cross-penetration with other disciplines. Its development integrates knowledge from different disciplines and also provides new directions and methods for development of the different disciplines.

In related art, a research project on the AI technology in a wireless air interface has been established for a Radio Access Network (RAN) to introduce the AI technology into the wireless air interface and assist in improving transmission technology of the wireless air interface. Moreover, it currently supports the application of the AI technology in the wireless air interfaces for communication processing, including AI model training and model inference application.

However, a wireless communication environment of the wireless air interface changes in real time, which will affect an inference performance of AI applied in the wireless air interface.

### SUMMARY

According to a first aspect of embodiments of the present disclosure, a communication method is provided. The method is performed by a terminal and includes: monitoring an inference performance of an AI model, in response to determining that air interface communication is performed between the terminal and a network device based on an AI model.

According to a second aspect of embodiments of the present disclosure, a communication method is provided. The method is performed by a network device, and includes: monitoring an inference performance of an AI model, in response to determining that air interface communication is performed between a terminal and the network device based on the AI model.

According to a third aspect of embodiments of the present disclosure, a terminal is provided. The terminal includes: a processor; a memory for storing instructions executable by the processor. The processor is configured to: monitor an inference performance of an AI model, in response to determining that air interface communication is performed between the terminal and a network device based on an AI model.

According to a fourth aspect of embodiments of the present disclosure, a network device is provided. The device includes: a processor; a memory for storing instructions executable by the processor. The processor is configured to perform the method described in the second aspect.

It should be understood that the foregoing general description and the following detailed descriptions are exemplary and explanatory only, and do not limit the present disclosure.

### BRIEF DESCRIPTION OF THE DRAWINGS

The accompanying drawings are incorporated in and constitute a part of the description, illustrate embodiments consistent with the present disclosure and together with the description, serve to explain the principles of the present disclosure.

FIG. 1 is a schematic diagram of a wireless communication system according to an embodiment.

FIG. 2 is a flowchart of a communication method applicable to a terminal according to an embodiment.

FIG. 3 is a flowchart of a communication method according to an embodiment.

FIG. 4 is a flowchart of a communication method according to an embodiment.

FIG. 5 is a flowchart of a communication method according to an embodiment.

FIG. 6a is a flowchart of a communication method according to an embodiment.

FIG. 6b is a flowchart of a communication method according to an embodiment.

FIG. 7 is a flowchart of a communication method according to an embodiment.

FIG. 8 is a flowchart of a communication method according to an embodiment.

FIG. 9 is a flowchart of a communication method according to an embodiment.

FIG. 10 is a flowchart of a communication method according to an embodiment.

FIG. 11 is a flowchart of a communication method according to an embodiment.

FIG. 12 is a flowchart of a communication method applicable to a network device according to an embodiment.

FIG. 13 is a flowchart of a communication method according to an embodiment.

FIG. 14 is a flowchart of a communication method according to an embodiment.

FIG. 15 is a flowchart of a communication method according to an embodiment.

FIG. 16a is a flowchart of a communication method according to an embodiment.

FIG. 16b is a flowchart of a communication method according to an embodiment.

FIG. 17 is a flowchart of a communication method according to an embodiment.

FIG. 18 is a flowchart of a communication method according to an embodiment.

FIG. 19a is a flowchart of a communication method according to an embodiment.

FIG. 19b is a flowchart of a communication method according to an embodiment.

FIG. 20 is a flowchart of a communication method according to an embodiment.

FIG. 21 is a flowchart of a communication method according to an embodiment.

FIG. 22 is a schematic diagram of a communication apparatus according to an embodiment.

FIG. 23 is a schematic diagram of a communication apparatus according to an embodiment.

FIG. 24 is a schematic diagram of a communication device according to an embodiment.

FIG. 25 is a schematic diagram of a communication device according to an embodiment.

### DETAILED DESCRIPTION

Embodiments will be described in detail in the present disclosure, examples of which are illustrated in the accompanying drawings. When the following description refers to the drawings, the same numbers in different drawings refer to the same or similar elements unless otherwise indicated. The implementations described in the following embodiments do not represent all implementations consistent with the present disclosure.

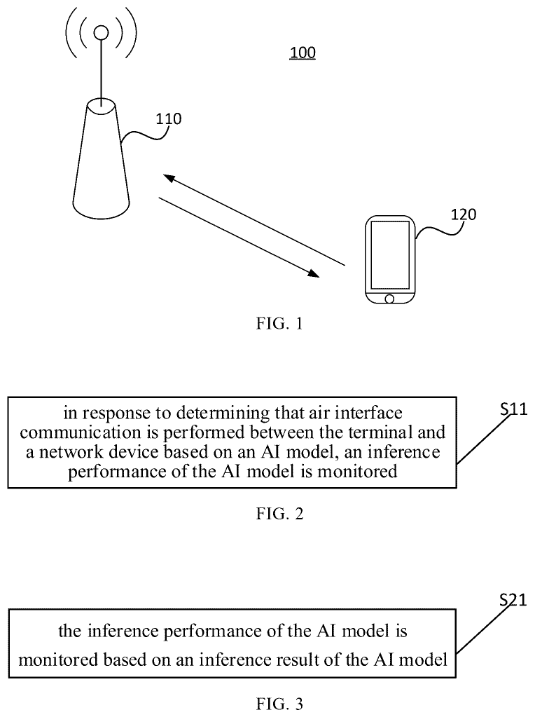

The communication method involved in the present disclosure is applicable to a wireless communication system 100 shown in FIG. 1. The network system may include a network device 110 and a terminal 120. It can be understood that the wireless communication system shown in FIG. 1 is only a schematic illustration, and the wireless communication system may also include other network device, such as a core network device, a wireless relay device, a wireless backhaul device, etc., which is not shown in FIG. 1. The embodiments of the present disclosure do not limit the number of network devices and terminals included in the wireless communication system.

It can be further understood that the wireless communication system of the embodiments of the present disclosure is a network that provides wireless communication functions. The wireless communication system may adopt different communication technologies, such as Code Division Multiple Access (CDMA), Wideband Code Division Multiple Access (WCDMA), Time Division Multiple Access (TDMA), Frequency Division Multiple Access (FDMA), Orthogonal Frequency-Division Multiple Access (OFDMA), Single Carrier FDMA, (SC-FDMA), or Carrier Sense Multiple Access with Collision Avoidance. According to different network capacity, speed, delay and other factors, the network can be divided into a 2-Generation(2G) network, a 3G network, a 4G network or future evolution network, such as a fifth generation wireless communication system (5G) network, which can be also called New Radio (NR). For convenience of description, the present disclosure sometimes refers to the wireless communication network as the network.

Furthermore, the network device 110 involved in the present disclosure may also be called a wireless access network device. The wireless access network device may be: a base station, an evolved Node B (eNB), a home base station, an access point (AP) in a wireless fidelity (WIFI) system, a wireless relay node, a wireless backhaul node or a transmission point (TP), etc. The wireless access network device may also be a gNB in the NR system, or may be a component or part of an equipment that constitutes the base station. When it is a vehicle-to-everything (V2X) communication system, the network device may also be a vehicle-mounted device. It should be understood that in the embodiments of the present disclosure, there are no limitations on the specific technology and specific equipment form used by the network device.

Further, the terminal 120 involved in the present disclosure may also be called a terminal device, a user equipment (UE), a mobile station (MS), a mobile terminal (MT), etc., and is a device that provides voice and/or data connectivity to the user. For example, the terminal may be a handheld device with wireless connection capabilities, a vehicle-mounted device, etc. Currently, some examples of the terminal are: a mobile phone, a pocket personal computer (PPC), a personal digital assistant (PDA), a notebook computer, a tablet computer, a wearable device, or a vehicle-mounted device, etc. In addition, when it is a vehicle-to-everything (V2X) communication system, the terminal may also be a vehicle-mounted device. It should be understood that the embodiments of the present disclosure do not limit the specific technology and specific equipment form used by the terminal.

In the embodiments of the present disclosure, the network device 110 and the terminal 120 may use any feasible wireless communication technology to transmit data to each other. A transmission channel on which the network device 110 sends data to the terminal 120 is called a downlink channel (DL), and a transmission channel on which the terminal 120 sends data to the network device 110 is called an uplink channel (UL). It can be understood that the network device involved in the embodiments of the present disclosure may be a base station. Of course, the network device may also be any other possible network device, and the terminal may be any possible terminal, which is not limited by the present disclosure.

Currently, in the related art, in the research on wireless AI technology, the AI-based application may include, for example: AI-based channel state information (CSI) enhancement, AI-based beam correlation, AI-based positioning, etc.

There are two very important stages involved in an AI operation. For example, a first stage may be a training stage of an AI model, that is, a stage of obtaining the AI model; a second stage may be a deployment stage of the AI model, that is, an inference application stage of the AI model.

However, as a wireless environment changes, an inference performance of the AI model may also be affected. However, there is currently no solution for monitoring a performance of the AI model.

Therefore, the present disclosure provides a communication method that monitors the inference performance of the AI model when communicating based on the AI model, thereby accurately understanding the inference situation of the AI model.

FIG. 2 is a flowchart of a communication method according to an embodiment. As shown in FIG. 2, the communication method is applicable to a terminal. The method may include the following step.

In step S11, in response to determining that air interface communication is performed between the terminal and a network device based on an AI model, an inference performance of the AI model is monitored.

In an embodiment of the present disclosure, in response to determining that the air interface communication is performed between the terminal and the network device based on the AI model, the terminal may perform performance monitoring on the corresponding AI model.

It is understood that the AI model may be pre-stored on the terminal or the network device. For example, when the terminal communicates with the network device and uses the communication method to invoke the pre-stored AI model, the performance of the invoked AI model may be monitored.

In some examples, the air interface communication may be considered as any possible communication mode, such as 5G, which is not limited by the present disclosure.

The present disclosure can monitor the inference performance of the AI model when communicating based on the AI model, thereby accurately understanding the inference situation of the AI model.

For communication methods provided by the embodiments of the present disclosure, FIG. 3 is a flowchart of another communication method according to an embodiment. As shown in FIG. 3, the communication method is applicable to a terminal, and the method may include the following steps.

In step S21, the inference performance of the AI model is monitored based on an inference result of the AI model.

In an embodiment of the present disclosure, the inference performance of the AI model invoked during the communication may be monitored based on the inference result of the AI model.

In some examples, the terminal may determine the inference result of the invoked AI model. The inference result may be a result obtained after the AI model performs inference application based on relevant information. Then the inference performance of the AI model may be monitored based on the inference result of the AI model.

The present disclosure uses the inference result of the AI model to monitor the inference performance, which can reflect the inference situation of the AI model more accurately and intuitively.

For communication methods provided by the embodiments of the present disclosure, FIG. 4 is a flowchart of yet another communication method according to an embodiment. As shown in FIG. 4, the communication method is applicable to a terminal. The monitoring the inference performance of the AI model based on the inference result of the AI model may include following steps.

In step S31, an inference object corresponding to the inference result of the AI model is determined.

In an embodiment of the present disclosure, the terminal may further determine the inference object corresponding to the inference result of the AI model. For example, the inference result of the AI model is a certain position (XX position), then the corresponding inference object may be an object or a person.

In step S32, the inference performance of the AI model is monitored based on an actual state of the inference object and the inference result of the AI model.

In an embodiment of the present disclosure, the terminal may monitor the inference performance of the AI model based on the actual state of the inference object and the inference result of the AI model.

For example, assuming that the inference result of the AI model is an XX position, the corresponding inference object may be an object or a person, and the actual state of the inference object may be a real position of the object or person. In some examples, the actual state of the inference object may also become a reference state and may be used as a standard for the inference result. The terminal compares the inference result based on the AI model with the reference state to complete the monitoring of the inference performance of the AI model.

In some examples, the actual state of the inference object may be directly obtained by the terminal, or may be obtained by the network device and sent to the terminal by the network device. Of course, the actual state may also be determined based on pre-configured information, which is not limited by the present disclosure.

In an example, taking a scenario where the AI model is applied to positioning, the terminal may compare coordinates of the terminal obtained through the inference based on the AI model with actual coordinates of the terminal, to obtain the performance of AI model.

The actual coordinates of the terminal may be obtained by the terminal through any method, such as a global navigation satellite system (GNSS), a Bluetooth, a WIFI, etc.

The present disclosure utilizes the actual state of the inference object and the inference result of the AI model to monitor the inference performance of the AI model, which can reflect the inference situation of the AI model more accurately and intuitively.

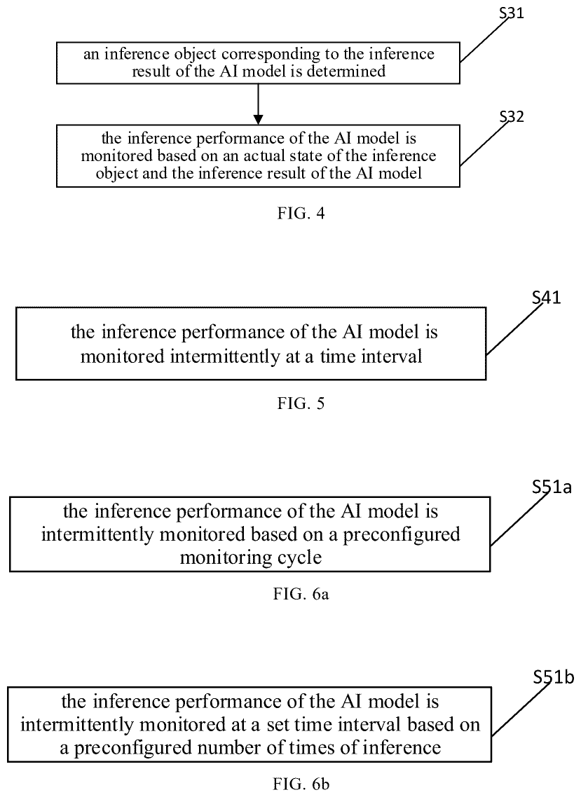

For communication methods provided by the embodiments of the present disclosure, FIG. 5 is a flowchart of yet another communication method according to an embodiment. As shown in FIG. 5, the communication method is applicable to a terminal. The monitoring the inference performance of the AI model may include a following step.

In step S41, the inference performance of the AI model is monitored intermittently at a time interval.

In an embodiment of the present disclosure, the terminal may intermittently monitor the inference performance of the AI model at a preset time interval. That is, the monitoring of the inference performance of the AI model may be intermittent in time.

The present disclosure, through intermittently monitoring the inference performance of the AI model, avoids performance loss caused by continuous monitoring and improves monitoring efficiency.

For communication methods provided by the embodiments of the present disclosure, FIG. 6a is a flowchart of another communication method according to an embodiment. As shown in FIG. 6a, the communication method is applicable to a terminal. The intermittently monitoring the inference performance of the AI model at the time interval may include a following step.

In step S51a, the inference performance of the AI model is intermittently monitored based on a preconfigured monitoring cycle.

In an embodiment of the present disclosure, based on the preconfigured monitoring cycle, the inference performance of the AI model may be monitored intermittently according to the monitoring cycle.

For example, assuming that the monitoring cycle is 10 ms, it means that the inference performance of the AI model is monitored every 10 ms. In this example, the time interval is 10 ms.

In some examples, the preconfigured monitoring cycle in step S51a may be preconfigured on the terminal, or may be preconfigured on the network device and sent to the terminal by the network device. Of course, it may also be pre-configured on any other device and sent to the terminal, which is not limited by the present disclosure.

The present disclosure uses the cyclically intermittent monitoring for the inference performance of the AI model, which can effectively avoid performance loss caused by continuous monitoring and improve monitoring efficiency, and which reduces the difficulty of configuring the time interval.

For communication methods provided by the embodiments of the present disclosure, FIG. 6b is a flowchart of another communication method according to an embodiment. As shown in FIG. 6b, the communication method is applicable to a terminal. The intermittently monitoring the inference performance of the AI model at the time interval may include a following step.

In step S51b, the inference performance of the AI model is intermittently monitored at a set time interval based on a preconfigured number of times of inference.

In an embodiment of the present disclosure, the inference performance of the AI model may be monitored intermittently based on the preconfigured number of times of inference and at the set time interval.

For example, if the preconfigured number of times of inference is 10, it means that the inference performance of the AI model will be monitored every 10 times of inference. In this example, the time interval is a time for performing 10 inferences.

In some examples, the preconfigured number of times of inference in step S51b may be preconfigured on the terminal, or may be preconfigured on the network device and sent to the terminal by the network device. Of course, the preconfigured number of times of inference may also be pre-configured on any other device and sent to the terminal, which is not limited in the present disclosure.

It can be understood that there is no order in which steps S51a and S51b are executed, and only one step may be executed. For example, only step S51a is executed, or only step S51b is executed. Of course, according to the actual situation, step S51a may be executed first and then step S51b, or step S51b may be executed first and then step S51a, which is not limited in the present disclosure.

The present disclosure intermittently monitors the inference performance of the AI model based on the number of times of inference, which can effectively avoid the performance loss caused by continuous monitoring and improve the monitoring efficiency, and which reduces the difficulty of configuring the time interval.

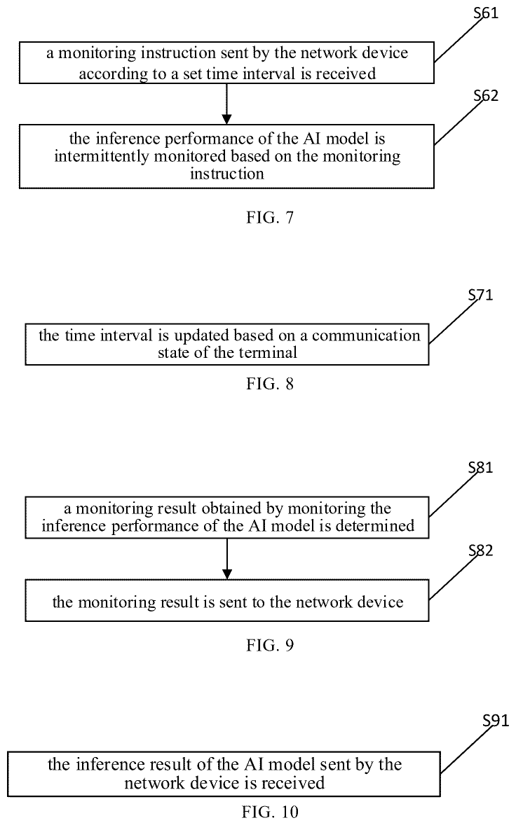

For communication methods provided by the embodiments of the present disclosure, FIG. 7 is a flowchart of yet another communication method according to an embodiment. As shown in FIG. 7, the communication method is applicable to a terminal. The intermittently monitoring the inference performance of the AI model at the time interval may include following steps.

Step S61, a monitoring instruction sent by the network device according to a set time interval is received.

In an embodiment of the present disclosure, the terminal may receive the monitoring instruction sent by the network device, and the monitoring instruction may be sent by the network device at the set time interval.

Step S62, the inference performance of the AI model is intermittently monitored based on the monitoring instruction.

In an embodiment of the present disclosure, the terminal may intermittently monitor the inference performance of the AI model based on the received monitoring instruction.

In other words, the terminal triggers monitoring of the inference performance of the AI model based on the monitoring instruction sent by the network device. It can be considered that the network device may send the monitoring instruction at any time based on an actual situation, and after receiving the monitoring instruction, the terminal may trigger the monitoring of the inference performance of the AI model based on the instruction.

In some examples, the monitoring instruction may trigger the terminal to perform monitoring only this time, cyclical monitoring, and/or intermittent monitoring based on the number of times of inference, which is not limited by the present disclosure.

Of course, it can be understood that there is no strict order of execution between steps S61 and S62 with the steps S51a and S51b. The steps S51a, S51b, and steps S61 and S62 may be regarded as three different intermittent monitoring manners. In some examples, any one, two, or all three of the three intermittent monitoring manners may be used. At the same time, the order in which the above-mentioned manners are executed during the intermittent monitoring is not limited.

The present disclosure can also trigger the monitoring for the inference performance of the AI model through the monitoring instruction sent by the network device, which can improve the flexibility of monitoring.

For communication methods provided by the embodiments of the present disclosure, FIG. 8 is a flowchart of yet another communication method according to an embodiment. As shown in FIG. 8, the communication method is applicable to a terminal, and the method may include a following step.

Step S71, the time interval is updated based on a communication state of the terminal.

In an embodiment of the present disclosure, the terminal may update the time interval based on the communication state of the terminal itself.

For example, when a moving speed of the terminal changes, it may affect the inference result of the AI model to a certain extent, which means it may affect the inference performance of the AI model. Therefore, the time interval may be updated based on the communication state of the terminal. This allows the terminal to intermittently monitor the inference performance of the AI model based on the updated time interval.

In some examples, when the moving speed of the terminal changes, the time interval is updated, so that the terminal may change the time interval for intermittently monitoring the inference performance of the AI model according to the change in the communication state.

The present disclosure can update the time interval based on the terminal's communication state, thereby improving the flexibility of monitoring the AI model inference performance. And the accuracy of monitoring can be guaranteed in case of an environment change, due to the targeted adjustment of the monitoring time interval.

For communication methods provided by the embodiments of the present disclosure, FIG. 9 is a flowchart of another communication method according to an embodiment. As shown in FIG. 9, the communication method is applicable to a terminal, and the method may include following steps.

Step S81, a monitoring result obtained by monitoring the inference performance of the AI model is determined.

In an embodiment of the present disclosure, the terminal may determine the monitoring result obtained by monitoring the inference performance of the AI model.

Step S82, the monitoring result is sent to the network device.

In an embodiment of the present disclosure, the terminal may send the determined monitoring result to the network device. It can be understood that sending the monitoring results to the network device may also be referred to as reporting the monitoring result to the network device.

It can be understood that the terminal may determine the corresponding monitoring result when monitoring the inference performance of the AI model, and then the monitoring result is fed back to the network device, so that the network device may perform a corresponding operation based on the received monitoring result.

The present disclosure, through reporting the monitoring result to the network device, enables the network device to perform the corresponding operation based on the monitoring result, and helps the network device to optimize the inference result of the AI model.

For communication methods provided by the embodiments of the present disclosure, sending the monitoring result to the network device includes at least one of: in response to determining that the monitoring result includes more than one monitoring result, sending the more than one monitoring result to the network device respectively; in response to determining that the monitoring result includes more than one monitoring result, sending an inference performance result to the network device, in which the inference performance result is obtained based on the more than one monitoring result; in response to the monitoring result meeting a preset condition, sending the monitoring result meeting the preset condition to the network device; cyclically sending the monitoring result to the network device based on a preconfigured inference performance reporting cycle; or sending the monitoring result to the network device based on a reporting instruction sent by the network device.

In an embodiment of the present disclosure, the terminal may send the determined more than one monitoring result to the network device respectively.

In an embodiment of the present disclosure, the terminal may determine the inference performance result based on the determined more than one monitoring result, and send the inference performance result to the network device. The inference performance result may be obtained based on more than one monitoring result.

In some examples, the inference performance result may be considered as information that may characterize the more than one monitoring result. For example, it may be obtained by calculating an average based on the more than one monitoring result. Of course, one monitoring result among the more than one monitoring result may also be selected as the inference performance result. Of course, a corresponding algebraic value may also be calculated based on the more than one monitoring result as the inference performance result, such as variance, standard deviation, algebraic sum, etc. The specific manner for obtaining the inference performance result may be randomly selected according to the actual situation, and is not limited by the present disclosure.

In an embodiment of the present disclosure, when the determined monitoring result meets the preset condition, the terminal may send the monitoring result meeting the preset condition to the network device.

For example, when a certain monitoring result is greater than or equal to a preset monitoring result threshold, the monitoring result may be sent to the network device. It can be understood that when the monitoring result meets the preset conditions, the inference performance of the AI model may have changed significantly, and thus timely feedback to the network device can help optimize the AI model.

In an embodiment of the present disclosure, the terminal may cyclically send the monitoring result to the network device based on the preconfigured inference performance reporting cycle.

In an embodiment of the present disclosure, the terminal may send the monitoring result to the network device based on the reporting instruction sent by the network device.

The present disclosure provides a variety of different ways of feeding back the monitoring results to the network device to ensure that the network device can know the inference performance of the AI model timely and accurately. At the same time, some solutions can avoid occupying too many communication resources and reduce excessive consumption of communication resources.

In the communication methods provided by the embodiment of the present disclosure, an inference node of the AI model is a terminal, and a performance monitoring node of the AI model is the terminal.

In some examples, the inference node and the performance monitoring node of the AI model in the above embodiments may be completed on the terminal side.

The present disclosure can complete the AI model inference and the performance monitoring on the terminal, and at the same time, the performance monitoring can be optimized by communicating with the network device, and the inference situation of the AI model can be accurately understood.

In the communication methods provided by the embodiment of the present disclosure, an inference node of the AI model is a network device, and a performance monitoring node of the AI model is a terminal. FIG. 10 is a flowchart of yet another communication method according to an embodiment. As shown in FIG. 10, the communication method is applicable to a terminal, and the method may include a following step.

Step S91, the inference result of the AI model sent by the network device is received.

In an embodiment of the present disclosure, the terminal may receive the inference result of the AI model sent by the network device. It can be understood that, since in this example, the inference node of the AI model is the network device, the terminal needs to obtain the inference result of the AI model from the network device.

In some examples, the network device may actively send the inference result of the AI model to the terminal. In other examples, the terminal may also trigger the network device to send the inference result of the AI model, for example, the terminal sends an inference result acquisition instruction to the network device. The network device obtains the inference result acquisition instruction and triggers sending the inference result of the AI model to the terminal. The present disclosure does not limit how the network device specifically sends the inference result of the AI model.

The present disclosure can complete the AI model inference on the network device and complete the performance monitoring on the terminal. Through the communication between the terminal and the network device, the AI model is collaboratively processed, and the inference of the AI model can be accurately understood.

In the communication methods provided by the embodiments of the present disclosure, an inference node of the AI model is the network device, and a performance monitoring node of the AI model is the network device.

In some examples, the inference node and the performance monitoring node of the AI model in the above embodiments can be completed on the network device side.

In some examples, since the inference and performance monitoring of the AI model are completed on the network device side, the network device side does not need to send the monitoring instruction to control the intermittent monitoring for the inference performance of the AI model. Of course, in some examples, the network device does not need to send the obtained monitoring result.

The present disclosure can complete the AI model inference and the performance monitoring on the network device, and can also trigger performance monitoring through communication with the terminal, so that the inference of the AI model can be accurately understood.

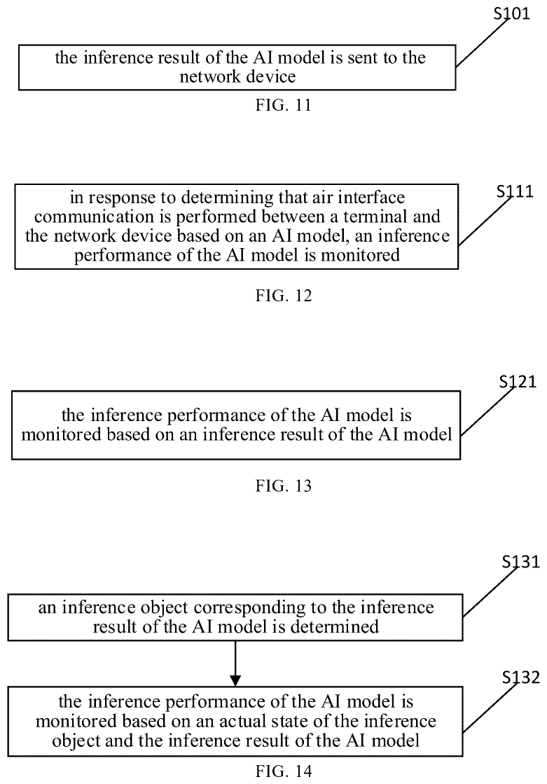

In the communication methods provided by the embodiments of the present disclosure, an inference node of the AI model is the terminal, and a performance monitoring node of the AI model is the network device. FIG. 11 is a flowchart of yet another communication method according to an embodiment. As shown in FIG. 11, the communication method is applicable to a terminal. The method may include a following step.

Step S101, the inference result of the AI model is sent to the network device.

In an embodiment of the present disclosure, the terminal may send the inference result of the AI model to the network device. It can be understood that, since in this example, the monitoring node of the AI model is the network device, the terminal needs to send the inference result of the AI model to the network device so that the network device may perform performance monitoring based on the inference result of the AI model sent by the terminal.

In some examples, the terminal may actively send the inference result of the AI model to the network device.

The present disclosure can complete the AI model inference on the terminal and complete the performance monitoring on the network device. Through the communication between the terminal and the network device, the AI model is collaboratively processed, and the inference of the AI model can be accurately understood.

FIG. 12 is a flowchart of another communication method according to an embodiment. As shown in FIG. 12, the communication method is applicable to a network device. The method can include a following steps.

In step S111, in response to determining that air interface communication is performed between a terminal and the network device based on an AI model, an inference performance of the AI model is monitored.

In some examples, the network device may determine the inference result of an invoked AI model. The inference result may be a result obtained after the AI model performs inference application based on relevant information. Then the inference performance of the AI model may be monitored based on the inference result of the AI model.

The present disclosure uses the inference result of the AI model to monitor the inference performance, which can reflect the inference situation of the AI model more accurately and intuitively.

For communication methods provided by the embodiments of the present disclosure, FIG. 13 is a flowchart of yet another communication method according to an embodiment. As shown in FIG. 13, the communication method is applicable to a network device. The method may include a following step.

In step S121, the inference performance of the AI model is monitored based on an inference result of the AI model.

In an embodiment of the present disclosure, the inference performance of the AI model invoked during the communication process may be monitored based on the inference result of the AI model.

In some examples, the network device may determine the inference result of the invoked AI model. The inference result may be a result obtained after the AI model performs inference application based on relevant information. Then the inference performance of the AI model may be monitored based on the inference result of the AI model.

The present disclosure uses the inference result of the AI model to monitor the inference performance, which can reflect the inference situation of the AI model more accurately and intuitively.

For communication methods provided by the embodiments of the present disclosure, FIG. 14 is a flowchart of yet another communication method according to an embodiment. As shown in FIG. 14, the communication method is applicable to a network device. The monitoring the inference performance of the AI model based on the inference result of the AI model may include following steps.

In step S131, an inference object corresponding to the inference result of the AI model is determined.

In an embodiment of the present disclosure, the network device may further determine the inference object corresponding to the inference result of the AI model. For example, the inference result of the AI model is a certain position (XX position), then the corresponding inference object may be an object or a person.

In step S132, the inference performance of the AI model is monitored based on an actual state of the inference object and the inference result of the AI model.

In an embodiment of the present disclosure, the network device may monitor the inference performance of the AI model based on the actual state of the inference object and the inference result of the AI model.

For example, assuming that the inference result of the AI model is an XX position, the corresponding inference object may be an object or a person, and the actual state of the inference object may be a real position of the object or person. In some examples, the actual state of the inference object may also become a reference state and may be used as a standard for the inference result. The terminal compares the inference result based on the AI model with the reference state to complete the monitoring of the inference performance of the AI model.

In some examples, the actual state of the inference object may be directly obtained by the network device, or may be obtained by the terminal and sent to the network device by the terminal. Of course, the actual state may also be determined based on pre-configured information, which is not limited by the present disclosure.

In an example, taking a scenario where the AI model is applied to positioning, the network device may compare coordinates of the network device obtained through the inference based on the AI model with actual coordinates of the network device, to obtain the performance of AI model.

The actual coordinates of the network device may be obtained by the network device through any method, such as a global navigation satellite system (GNSS), a Bluetooth, a WIFI, etc.

The present disclosure utilizes the actual state of the inference object and the inference result of the AI model to monitor the inference performance of the AI model, which can reflect the inference situation of the AI model more accurately and intuitively.

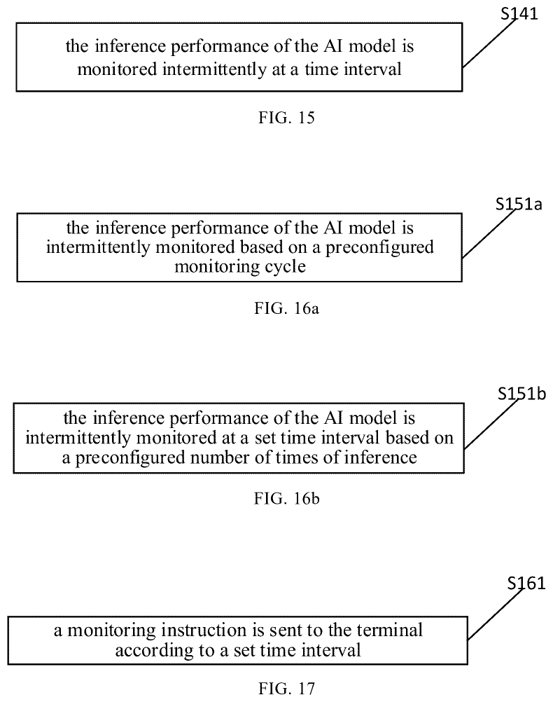

For communication methods provided by the embodiments of the present disclosure, FIG. 15 is a flowchart of another communication method according to an embodiment. As shown in FIG. 15, the communication method is applicable to a network device. The monitoring the inference performance of the AI model may include a following step.

In step S141, the inference performance of the AI model is monitored intermittently at a time interval.

In an embodiment of the present disclosure, the network device may intermittently monitor the inference performance of the AI model at a preset time interval. That is, the monitoring of the inference performance of the AI model may be intermittent in time.

The present disclosure, through intermittently monitoring the inference performance of the AI model, avoids performance loss caused by continuous monitoring and improves monitoring efficiency.

For communication methods provided by the embodiments of the present disclosure, FIG. 16a is a flowchart of yet another communication method according to an embodiment. As shown in FIG. 16a, the communication method is applicable to a network device. The intermittently monitoring the inference performance of the AI model at the time interval may include a following step.

In step S151a, the inference performance of the AI model is intermittently monitored based on a preconfigured monitoring cycle.

In an embodiment of the present disclosure, based on the preconfigured monitoring cycle, the inference performance of the AI model may be monitored intermittently according to the monitoring cycle.

For example, assuming that the monitoring cycle is 10 ms, it means that the inference performance of the AI model is monitored every 10 ms. In this example, the time interval is 10 ms.

In some examples, the preconfigured monitoring cycle in step S51a may be preconfigured on the network device, or may be preconfigured on the terminal and sent to the network device by the terminal. Of course, it may also be pre-configured on any other device and sent to the network device, which is not limited by the present disclosure.

The present disclosure uses the cyclically intermittent monitoring for the inference performance of the AI model, which can effectively avoid performance loss caused by continuous monitoring and improve monitoring efficiency, and which reduces the difficulty of configuring the time interval.

For communication methods provided by the embodiments of the present disclosure, FIG. 16b is a flowchart of yet another communication method according to an embodiment. As shown in FIG. 16b, the communication method is applicable to a network device. The intermittently monitoring the inference performance of the AI model at the time interval may include a following step.

In step S151b, the inference performance of the AI model is intermittently monitored at a set time interval based on a preconfigured number of times of inference.

In an embodiment of the present disclosure, the inference performance of the AI model may be monitored intermittently based on the preconfigured number of times of inference and at the set time interval.

For example, if the preconfigured number of times of inference is 10, it means that the inference performance of the AI model will be monitored every 10 times of inference. In this example, the time interval is a time for performing 10 inferences.

In some examples, the preconfigured number of times of inference in step S151b may be preconfigured on the network device, or may be preconfigured on the terminal and sent to the network device by the terminal. Of course, the preconfigured number of times of inference may also be pre-configured on any other device and sent to the network device, which is not limited in the present disclosure.

It can be understood that there is no order in which steps S151a and S151b are executed, and only one step may be executed. For example, only step S151a is executed, or only step S151b is executed. Of course, according to the actual situation, step S151a may be executed first and then step S151b, or step S151b may be executed first and then step S151a, which is not limited in the present disclosure.

The present disclosure intermittently monitors the inference performance of the AI model based on the number of times of inference, which can effectively avoid the performance loss caused by continuous monitoring and improve the monitoring efficiency, and which reduces the difficulty of configuring the time interval.

For communication methods provided by the embodiments of the present disclosure, FIG. 17 is a flowchart of yet another communication method according to an embodiment. As shown in FIG. 17, the communication method is applicable to a network device. The method may include a following step.

In step S161, a monitoring instruction is sent to the terminal according to a set time interval.

In an embodiment of the present disclosure, the network device may send the monitoring instruction to the terminal according to the set time interval.

It can be understood that the network device may dynamically trigger the terminal to perform performance monitoring by sending the monitoring instruction, so that the terminal may monitor the inference performance of the AI model in a timely manner.

The present disclosure can also trigger the monitoring of the inference performance of the AI model through the monitoring instruction sent by the network device, which can improve the flexibility of monitoring.

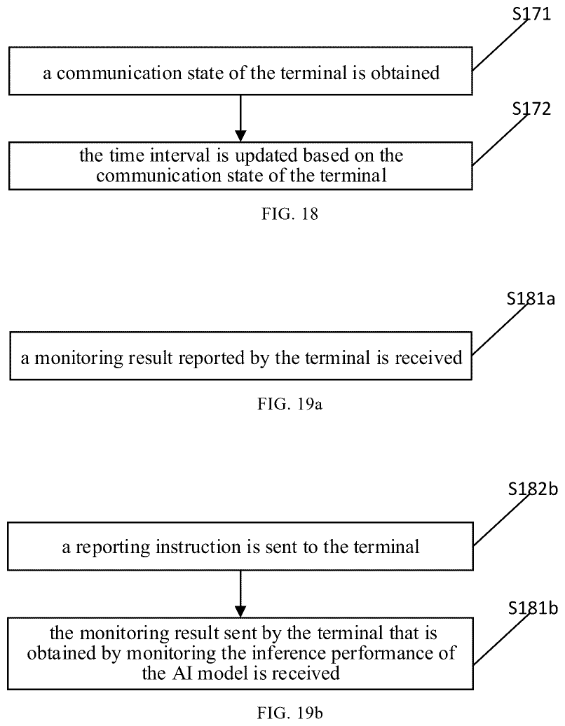

For communication methods provided by the embodiments of the present disclosure, FIG. 18 is a flowchart of another communication method according to an embodiment. As shown in FIG. 18, the communication method is applicable to a network device. The method may include following steps.

Step S171: a communication state of the terminal is obtained.

In an embodiment of the present disclosure, the network device may obtain the communication state of the terminal.

For example, when a moving speed of the terminal changes, it may affect the inference result of the AI model to a certain extent, which means it may affect the inference performance of the AI model. Therefore, the network device may obtain the current communication state of the terminal.

It can be understood that the communication state of the terminal may be actively sent to the network device by the terminal, or may be determined by the network device through relevant information. The present disclosure does not limit how the network device obtains the communication state of the terminal.

Step S172, the time interval is updated based on the communication state of the terminal.

In an embodiment of the present disclosure, the network device may update the time interval based on the obtained communication state of the terminal.

For example, the network device may update the time interval based on the communication state of the terminal. This allows the network device to intermittently monitor the inference performance of the AI model based on the updated time interval.

In some examples, when the moving speed of the terminal changes, the time interval is updated, so that the network device may change the time interval for intermittently monitoring the inference performance of the AI model based on the change of the communication state of the terminal.

The network device in the present disclosure can update the time interval based on the terminal's communication state, thereby improving the flexibility of monitoring the AI model inference performance. And the accuracy of monitoring can be guaranteed in case of an environment change, due to the targeted adjustment of the monitoring time interval.

For communication methods provided by the embodiments of the present disclosure, FIG. 19a is a flowchart of yet another communication method according to an embodiment. As shown in FIG. 19a, the communication method is applicable to a network device. The method may include a following step.

Step S181a: a monitoring result reported by the terminal is received.

In an embodiment of the present disclosure, the network device may obtain the monitoring result reported by the terminal.

It can be understood that if the terminal is configured to monitor the inference performance of the AI model, the network device may receive the monitoring result reported by the terminal that is obtained by monitoring the inference performance of the AI model. This process may also be considered as reporting the monitoring result from the terminal to the network device.

It can be understood that by receiving the monitoring result sent by the terminal, the network device may be caused to perform the corresponding operation based on the received monitoring result.

The present disclosure, through receiving the monitoring result reported by the terminal, enables the network device to perform the corresponding operation based on the monitoring result, and helps the network device to optimize the inference result of the AI model.

For the communication methods provided by the embodiment of the present disclosure, receiving the monitoring result sent by the terminal includes at least one of: receiving more than one monitoring result sent by the terminal; receiving an inference performance result sent by the terminal, in which the inference performance result is obtained based on more than one monitoring result; receiving a monitoring result meeting a preset condition sent by the terminal; receiving the monitoring result sent by the terminal based on a preconfigured inference performance reporting cycle.

In an embodiment of the present disclosure, the network device may receive the more than one monitoring result sent by the terminal respectively.

In an embodiment of the present disclosure, the network device may receive the inference performance result sent by the terminal. The inference performance result may be obtained by the terminal based on more than one monitoring result.

In some examples, the inference performance result may be considered as information that may characterize the more than one monitoring result. For example, it may be obtained by calculating an average based on the more than one monitoring result. Of course, one monitoring result among the more than one monitoring result may also be selected as the inference performance result. Of course, a corresponding algebraic value may also be calculated based on the more than one monitoring result as the inference performance result, such as variance, standard deviation, algebraic sum, etc. The specific manner for obtaining the inference performance result may be randomly selected according to the actual situation, and is not limited by the present disclosure.

In an embodiment of the present disclosure, the network device may receive the monitoring result sent by the terminal that meets the preset condition.

It can be understood that when the monitoring result meets the preset condition, the inference performance of the AI model may have changed significantly. Therefore, the network device receives the monitoring result that meets the preset condition, which can help optimize the AI model.

In an embodiment of the present disclosure, the network device may periodically receive the monitoring result sent by the terminal based on the preconfigured inference performance reporting cycle.

The present disclosure provides a variety of different ways for the network device to receive the monitoring result sent by the terminal to ensure that the network device can know the inference performance of the AI model timely and accurately. At the same time, some solutions can avoid occupying too many communication resources and reduce excessive consumption of communication resources.

In some embodiments, FIG. 19b is a flowchart of yet another communication method according to an embodiment. As shown in FIG. 19b, the communication method is applicable to a network device. The receiving the monitoring result sent by terminal may further includes following steps.

Step S182b, a reporting instruction is sent to the terminal.

In an embodiment of the present disclosure, the network device may send the reporting instruction to the terminal. In some examples, the reporting instruction may be used to trigger the terminal to send the monitoring result to the network device. In some examples, the reporting instruction may instruct the terminal to report in a corresponding manner, such as reporting each monitoring result to the network device, or instructing the terminal to feedback the inference performance result that can characterize the more than one monitoring result based on the more than one monitoring result, or instructing the terminal to feed back the monitoring result meeting the preset condition, etc., which is not limited by the present disclosure.

Step S181b, the monitoring result sent by the terminal that is obtained by monitoring the inference performance of the AI model is received.

In an embodiment of the present disclosure, the network device may receive the monitoring result sent by the terminal that is obtained by monitoring the inference performance of the AI model.

The present disclosure, through dynamically instructing the terminal to report the monitoring result by the network device, can also ensuring that the network device can obtain the inference performance of the AI model in a timely and accurate manner. At the same time, it can avoid occupying too many communication resources and reduce excessive consumption of communication resources.

In the communication methods provided by the embodiments of the present disclosure, an inference node of the AI model is the network device, and a performance monitoring node of the AI model is the network device.

In some examples, the inference node and the performance monitoring node of the AI model in the above embodiments can be completed on the network device side.

The present disclosure can complete the AI model inference and the performance monitoring on the network device. At the same time, the performance monitoring can be optimized through communication with the terminal, and the inference situation of the AI model can be accurately understood.

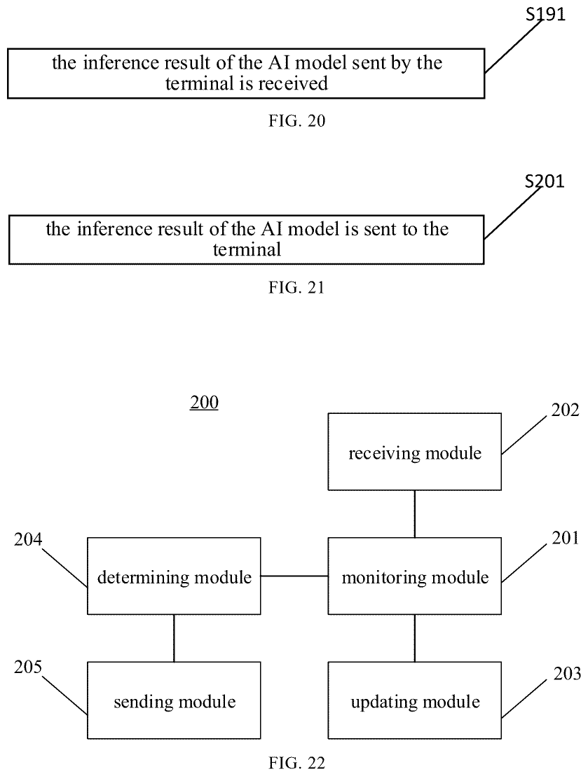

In the communication methods provided by the embodiments of the present disclosure, an inference node of the AI model is the terminal, and a performance monitoring node of the AI model is the network device. FIG. 20 is a flowchart of yet another communication method according to an embodiment. As shown in FIG. 20, the communication method is applicable to a network device. The method may include a following step.

Step S191, the inference result of the AI model sent by the terminal is received.

In an embodiment of the present disclosure, the network device may receive the inference result of the AI model sent by the terminal. It can be understood that, since in this example, the inference node of the AI model is the terminal, the network device needs to obtain the inference result of the AI model from the terminal.

In some examples, the terminal may actively send the inference result of the AI model to the network device. In some other examples, the network device may also trigger the terminal to send the inference result of the AI model, for example, the network device sends an inference result acquisition instruction to the terminal, and the terminal obtains the inference result acquisition instruction and is triggered to send the inference result of the AI model to the network device. The present disclosure does not limit how the terminal sends the inference result of the AI model.

The present disclosure can complete the AI model inference on the terminal and complete the performance monitoring on the network device. Through the communication between the terminal and the network device, the AI model is collaboratively processed, and the inference of the AI model can be accurately understood.

In the communication methods provided by the embodiments of the present disclosure, an inference node of the AI model is the terminal, and a performance monitoring node of the AI model is the terminal.

In some examples, the inference node and performance monitoring node of the AI model in the above embodiments may be completed on the terminal side.

In some examples, since the inference and performance monitoring of the AI model are completed on the terminal side, the terminal side may intermittently monitor the inference performance of the AI model based on the monitoring instruction control. Of course, in some examples, the terminal may also send the monitoring result obtained by monitoring to the network device.

The present disclosure can complete the AI model inference and the performance monitoring on the terminal, and can also trigger the performance monitoring through the communication with the network device, so that the inference of the AI model can be accurately understood.

In the communication methods provided by the embodiments of the present disclosure, an inference node of the AI model is the network device, and a performance monitoring node of the AI model is the terminal. FIG. 21 is a flowchart of another communication method according to an embodiment. As shown in FIG. 21, the communication method is applicable to a network device. The method may include a following step.

Step S201, the inference result of the AI model is sent to the terminal.

In an embodiment of the present disclosure, the network device may send the inference result of the AI model to the terminal. It can be understood that, since in this example, the monitoring node of the AI model is the terminal, the network device needs to send the inference result of the AI model to the terminal, so that the terminal may perform the performance monitoring based on the inference result of the AI model sent by the network device.

In some examples, the network device may actively send the inference result of the AI model to the terminal.

The present disclosure can complete the AI model inference on the network device and complete the performance monitoring on the terminal. Through the communication between the terminal and the network device, the AI model is collaboratively processed, and the inference of the AI model can be accurately understood.

It should be understood that the execution modes of the terminal and the network device are similar. Therefore, for details, reference may be made to the corresponding descriptions for the terminal, and will not be repeated here.

It should be noted that those skilled in the art can understand that the various implementations/embodiments mentioned above in the embodiments of the present disclosure can be used in conjunction with the foregoing embodiments or can be used independently. Whether used alone or in conjunction with the foregoing embodiments, the implementation principles are similar. In the implementation of the present disclosure, some embodiments are described in terms of implementations used together. Of course, those skilled in the art can understand that such illustrations do not limit the embodiments of the present disclosure.

It can be understood that the present disclosure can better balance the complex relationship between the inference performance and the monitoring for the AI model performance monitoring, thereby improving the efficiency of the model performance monitoring.

Based on the same concept, embodiments of the present disclosure also provide a communication apparatus.

It can be understood that, in order to implement the above functions, the communication apparatus provided by embodiments of the present disclosure includes hardware structures and/or software modules corresponding to respective functions. Combined with the units and algorithm steps of each example disclosed in the embodiments of the present disclosure, the embodiments of the present disclosure may be implemented in the form of hardware or a combination of hardware and computer software. Whether a function is performed by hardware or computer software driving the hardware depends on the specific application and design constraints of the technical solution. Those skilled in the art can use different methods to implement the described functions for each specific application, but such implementation should not be considered to go beyond the scope of the technical solutions of the embodiments of the present disclosure.

FIG. 22 is a schematic diagram of a communication apparatus according to an embodiment. Referring to FIG. 22, the apparatus 200 may be a terminal, and the apparatus 200 may include: a monitoring module 201, configured to monitor an inference performance of an AI model, in response to determining that air interface communication is performed between the terminal and a network device based on the AI model. The present disclosure can monitor the inference performance of the AI model when communicating based on the AI model, thereby accurately understanding the inference situation of the AI model.

The present disclosure can monitor the inference performance of the AI model when communicating based on the AI model, thereby accurately understanding the inference situation of the AI model.

In an implementation, the monitoring module 201 is further configured to monitor the inference performance of the AI model based on an inference result of the AI model.

The present disclosure uses the inference result of the AI model to monitor the inference performance, which can reflect the inference situation of the AI model more accurately and intuitively.

In an implementation, the monitoring module 201 is further configured to: determine an inference object corresponding to the inference result of the AI model; and monitor the inference performance of the AI model based on an actual state of the inference object and the inference result of the AI model.

The present disclosure utilizes the actual state of the inference object and the inference result of the AI model to monitor the inference performance of the AI model, which can reflect the inference situation of the AI model more accurately and intuitively.

In an implementation, the monitoring module 201 is further configured to intermittently monitor the inference performance of the AI model at a time interval.

The present disclosure intermittently monitors the inference performance of the AI model, avoiding the performance loss caused by continuous monitoring and improving the monitoring efficiency.

In an implementation, the monitoring module 201 is further configured to intermittently monitor the inference performance of the AI model at the time interval using at least one of following manners: intermittently monitoring the inference performance of the AI model based on a preconfigured monitoring cycle; or intermittently monitoring the inference performance of the AI model at a set time interval based on a preconfigured number of times of inference.

The present disclosure monitors the inference performance of the AI model periodically or intermittently according to the number of times of inference, which can effectively avoid the performance loss caused by continuous monitoring and improve the monitoring efficiency, and reduces the difficulty of configuring the time interval.

In an implementation, the device 200 also includes: a receiving module 202, configured to receive a monitoring instruction sent by the network device at a set time interval; and the monitoring module 201 is further configured to intermittently monitor the inference performance of the AI model based on the monitoring instruction.

The present disclosure can also trigger the monitoring of the inference performance of the AI model through the monitoring instruction sent by the network device, which can improve the flexibility of monitoring.

In an implementation, the device 200 further includes: an updating module 203, configured to update the time interval based on a communication state of the terminal.

The present disclosure can update the time interval based on the terminal communication state, thereby improving the flexibility of monitoring the AI model inference performance. And the accuracy of monitoring can be guaranteed under an environment change, due to the targeted adjustment of the monitoring time interval.

In an implementation, the apparatus 200 further includes: a determining module 204, configured to determine a monitoring result obtained by monitoring the inference performance of the AI model; and a sending module 205, configured to send the monitoring result to the network device.

Through reporting the monitoring result to the network device, the present disclosure enables the network device to perform corresponding operation based on the monitoring result, and helps the network device to optimize the inference result of the AI model.

In an implementation, the sending module 205 is further configured to send the monitoring result to the network device using at least one of following manners: in response to determining that the monitoring result includes more than one monitoring result, sending the more than one monitoring result to the network device respectively; in response to determining that the monitoring result includes more than one monitoring result, sending an inference performance result to the network device, in which the inference performance result is obtained based on the more than one monitoring result; in response to the monitoring result meeting a preset condition, sending the monitoring result meeting the preset condition to the network device; cyclically sending the monitoring result to the network device based on a preconfigured inference performance reporting cycle; or sending the monitoring result to the network device based on a reporting instruction sent by the network device.

The present disclosure provides a variety of different ways of feeding back the monitoring result to the network device to ensure that network device can know the inference performance of the AI model in a timely and accurate manner. At the same time, some solutions can avoid occupying too many communication resources and reduce excessive consumption of communication resources.

In an implementation, an inference node of the AI model is the terminal, and a performance monitoring node of the AI model is the terminal.

The present disclosure can complete the AI model inference and the performance monitoring on the terminal, and at the same time, the performance monitoring can be optimized by communicating with the network device, and the inference situation of the AI model can be accurately understood.

In an implementation, an inference node of the AI model is the network device, and a performance monitoring node of the AI model is the terminal; the apparatus 200 further includes: a receiving module 202, configured to receive the inference result of the AI model sent by the network device.

The present disclosure can complete the AI model inference on the network device and complete the performance monitoring on the terminal. Through the communication between the terminal and the network device, the AI model is collaboratively processed, and the inference of the AI model can be accurately understood.

In an implementation, an inference node of the AI model is the network device, and a performance monitoring node of the AI model is the network device.

The present disclosure can complete the AI model inference and the performance monitoring on the network device, and can also trigger the performance monitoring through communication with the terminal, so that the inference of the AI model can be accurately understood.

In an implementation, an inference node of the AI model is the terminal, and a performance monitoring node of the AI model is the network device; the apparatus 200 further includes: a sending module 205, configured to send the inference result of the AI model to the network device.

The present disclosure can complete the AI model inference on the terminal and complete the performance monitoring on the network device. Through the communication between the terminal and the network device, the AI model is collaboratively processed, and the inference of the AI model can be accurately understood.

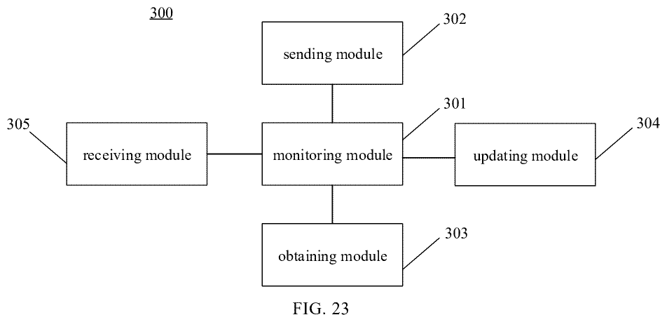

FIG. 23 is a schematic diagram of a communication apparatus according to an embodiment. Referring to FIG. 23, the apparatus 300 may be a network device. The apparatus 300 may include: a monitoring module 301, configured to monitor an inference performance of an AI model, in response to determining that air interface communication is performed between a terminal and the network device based on the AI model. The present disclosure can monitor the inference performance of the AI model when communicating based on the AI model, thereby accurately understanding the inference situation of the AI model.

The present disclosure uses the inference result of the AI model to monitor the inference performance, which can reflect the inference situation of the AI model more accurately and intuitively.

In an implementation, the monitoring module 301 is further configured to monitor the inference performance of the AI model based on an inference result of the AI model.

The present disclosure uses the inference result of the AI model to monitor the inference performance, which can reflect the inference situation of the AI model more accurately and intuitively.

In an implementation, the monitoring module 301 is further configured to: determine an inference object corresponding to the inference result of the AI model; and monitor the inference performance of the AI model based on an actual state of the inference object and the inference result of the AI model.

The present disclosure utilizes the actual state of the inference object and the inference result of the AI model to monitor the inference performance of the AI model, which can reflect the inference situation of the AI model more accurately and intuitively.

In an implementation, the monitoring module 301 is further configured to intermittently monitor the inference performance of the AI model at a time interval.

The present disclosure monitors the inference performance of the AI model intermittently, avoiding the performance loss caused by continuous monitoring and improving the monitoring efficiency.

In an implementation, the monitoring module 301 is further configured to intermittently monitor the inference performance of the AI model at the time interval using at least one of following manners: intermittently monitoring the inference performance of the AI model based on a preconfigured monitoring cycle; or intermittently monitoring the inference performance of the AI model at a set time interval based on a preconfigured number of times of inference.

The present disclosure monitors the inference performance of the AI model periodically or intermittently according to the number of times of inference, which can effectively avoid the performance loss caused by continuous monitoring and improve the monitoring efficiency, and reduces the difficulty of configuring the time interval.

In an implementation, the apparatus 300 further includes: a sending module 302, configured to send a monitoring instruction to the terminal at a set time intervals.

The present disclosure can also trigger the monitoring of the inference performance of the AI model through the monitoring instruction sent by the network device, which can improve the flexibility of monitoring.

In an implementation, the apparatus 300 further includes: an obtaining module 303, configured to obtain a communication state of the terminal; and an updating module 304, configured to update the time interval based on the communication state of the terminal.

The disclosed network device can update the time interval based on the terminal's communication state, thereby improving the flexibility of monitoring the AI model inference performance. And the accuracy of monitoring can be guaranteed in case of an environment change, due to the targeted adjustment of the monitoring time interval.

In an implementation, the apparatus 300 further includes: a receiving module 305, configured to receive a monitoring result sent by the terminal.

Through receiving the monitoring result reported by the terminal, the present disclosure enables the network device to perform the corresponding operation based on the monitoring result, and helps the network device to correspondingly optimize the inference result of the AI model.

In an implementation, the receiving module 305 is also configured to: receive more than one monitoring result sent by the terminal; receive an inference performance result sent by the terminal, in which the inference performance result is obtained based on more than one monitoring result; receive a monitoring result meeting a preset condition sent by the terminal; or cyclically receive the monitoring result sent by the terminal based on a preconfigured inference performance reporting cycle; or the apparatus 300 further includes: a sending module 302, configured to send a reporting instruction to the terminal; and a receiving module 305, configured to receive the monitoring result sent by the terminal that is obtained by monitoring the inference performance of the AI model.

The present disclosure provides a variety of different ways for the network device to receive the monitoring result sent by the terminal to ensure that the network device can know the inference performance of the AI model timely and accurately. At the same time, some solutions can avoid occupying too many communication resources and reduce excessive consumption of communication resources.

In an implementation, an inference node of the AI model is the network device, and a performance monitoring node of the AI model is the network device.

The present disclosure can complete the AI model inference and the performance monitoring on the network device. At the same time, the performance monitoring can be optimized through communication with the terminal, and the inference situation of the AI model can be accurately understood.

In an implementation, an inference node of the AI model is the terminal, and a performance monitoring node of the AI model is the network device; the apparatus 300 further includes: a receiving module 305, configured to receive the inference result of the AI model sent by the terminal.

The present disclosure can complete the AI model inference on the terminal and complete the performance monitoring on the network device. Through the communication between the terminal and the network device, the AI model is collaboratively processed, and the inference of the AI model can be accurately understood.

In an implementation, an inference node of the AI model is the terminal, and a performance monitoring node of the AI model is the terminal.

The present disclosure can complete the AI model inference and the performance monitoring on the terminal, and can also trigger the performance monitoring through communication with network device, so that the inference of the AI model can be accurately understood.

In an implementation, an inference node of the AI model is the network device, and a performance monitoring node of the AI model is the terminal; the apparatus 300 further includes: a sending module 302, configured to send the inference result of the AI model to the terminal.

The present disclosure can complete the AI model inference on the network device and complete the performance monitoring on the terminal. Through the communication between the terminal and the network device, the AI model is collaboratively processed, and the inference of the AI model can be accurately understood.

Regarding the apparatuses in the above embodiments, the specific manner in which each module performs operations has been described in detail in the embodiments related to the method, and will not be described in detail here.

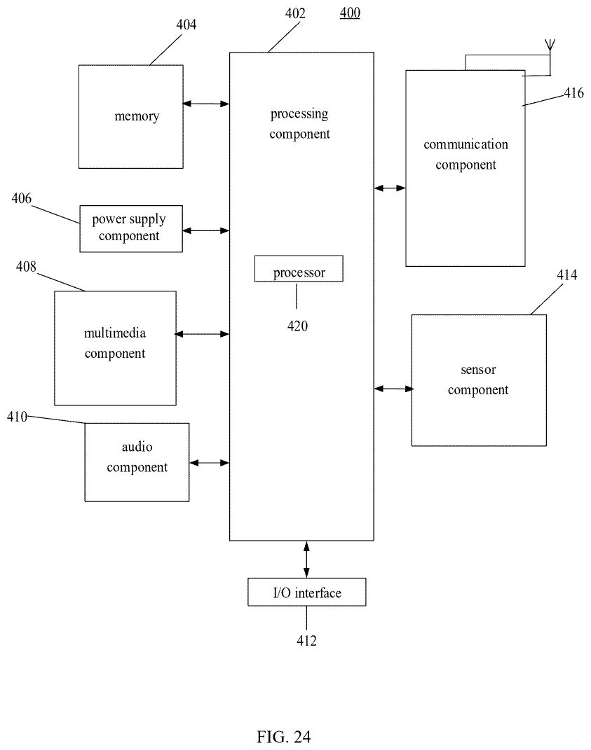

FIG. 24 is a block diagram of a communication device 400 according to an embodiment. For example, the communication device 400 may be a mobile phone, a computer, a digital broadcast user device, a messaging device, a game console, a tablet device, a medical device, a fitness device, a personal digital assistant, or the like.

Referring to FIG. 24, the communication device 400 may include one or more of: a processing component 402, a memory 404, a power supply component 406, a multimedia component 408, an audio component 410, an input/output (I/O) interface 412, and a sensor component 414, and a communication component 416.

The processing component 402 generally controls the overall operations of the communication device 400, such as operations associated with display, phone calls, data communications, camera operations, and recording operations. The processing component 402 may include one or more processors 420 to execute instructions to complete all or part of the steps of the above method. Additionally, the processing component 402 may include one or more modules that facilitate interaction between processing component 402 and other components. For example, the processing component 402 may include a multimedia module to facilitate interaction between the multimedia component 408 and the processing component 402.

The memory 404 is configured to store various types of data to support operations at the communication device 400. Examples of such data include instructions for any application or method operating on the communication device 400, contact data, phonebook data, messages, pictures, videos, etc. The memory 404 may be implemented by any type of volatile or non-volatile storage device, or their combination, such as a static random access memory (SRAM), an electrically erasable programmable read-only memory (EEPROM), an erasable programmable read-only memory (EEPROM), a programmable read-only memory (EPROM), a programmable read-only memory (PROM), a read-only memory (ROM), a magnetic memory, a flash memory, a magnetic or optical disk.

The power supply component 406 provides power to various components of the communication device 400. The power supply component 406 may include a power management system, one or more power supplies, and other components associated with generating, managing, and distributing power to the communication device 400.

The multimedia component 408 includes a screen that provides an output interface between the communication device 400 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensor may not only sense the boundary of a touch or slide action, but also detect the duration and pressure associated with the touch or slide action. In some embodiments, the multimedia component 408 includes a front-facing camera and/or a rear-facing camera. When the communication device 400 is in an operating mode, such as a shooting mode or a video mode, the front camera and/or the rear camera may receive external multimedia data. Each front-facing camera and rear-facing camera may be a fixed optical lens system or have a focal length and optical zoom capabilities.

The audio component 410 is configured to output and/or input an audio signal. For example, the audio component 410 includes a microphone (MIC) configured to receive the external audio signal when the communication device 400 is in an operating mode, such as a call mode, a recording mode, and a speech recognition mode. The received audio signal may be further stored in the memory 404 or sent via the communication component 416. In some embodiments, the audio component 410 also includes a speaker for outputting audio signals.

The I/O interface 412 provides an interface between the processing component 402 and a peripheral interface module. The peripheral interface module may be a keyboard, a click wheel, a button, etc. These button may include, but is not limited to: a home button, a volume button, a start button, and a lock button.

The sensor component 414 includes one or more sensors that provide various aspects of status assessment for the communication device 400. For example, the sensor component 414 may detect the open/closed state of the communication device 400, the relative positioning of components, such as a display and a keypad of the communication device 400, the sensor component 414 may also detect a position change of the communication device 400 or a component of the communication device 400, presence or absence of user contact with the communication device 400, an orientation or an acceleration/deceleration of the communication device 400, and a temperature change of the communication device 400. The sensor component 414 may include a proximity sensor configured to detect presence of nearby objects without any physical contact. The sensor component 414 may also include a light sensor, such as a CMOS or CCD image sensor, for use in imaging applications. In some embodiments, the sensor component 414 may also include an acceleration sensor, a gyroscope sensor, a magnetic sensor, a pressure sensor, or a temperature sensor.

The communication component 416 is configured to facilitate wired or wireless communication between the communication device 400 and other devices. The communication device 400 may access a wireless network based on a communication standard, such as WiFi, 2G, or 3G, or their combination. In an embodiment, the communication component 416 receives a broadcast signal or broadcast related information from an external broadcast management system via a broadcast channel. In an embodiment, the communication component 416 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In an embodiment, the communication device 400 may be configured by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components used to perform the above methods.

In an embodiment, there is provided a non-transitory computer-readable storage medium including instructions, for example a memory 404 including instructions that can be executed by the processor 420 of the communication device 400 to complete the above methods. For example, the non-transitory computer-readable storage medium may be a ROM, a random access memory (RAM), a CD-ROM, a magnetic tape, a floppy disk, an optical data storage device, etc.

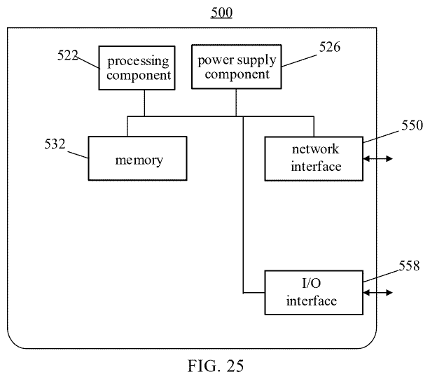

FIG. 25 is a schematic diagram of a communication device 500 according to an embodiment. For example, the device 500 is a network device, which may be provided as a base station or a server. Referring to FIG. 25, the device 500 includes a processing component 522, which further includes one or more processors, and memory resources represented by a memory 532 for storing instructions, such as an application program, executable by processing component 522. The application program stored in memory 532 may include one or more modules, each corresponding to a set of instructions. In addition, the processing component 522 is configured to execute the instructions to perform the communication methods corresponding to the network device in the above methods.

The device 500 may also include a power supply component 526 configured to perform power management of the device 500, a wired or wireless network interface 550 configured to connect the device 500 to a network, and an input-output (I/O) interface 558. The device 500 may operate based on an operating system stored in memory 532, such as Windows Server™, Mac OS X™, Unix™, Linux™, FreeBSD™ or the like.

It can be further understood that “multiple” in the present disclosure refers to two or more, and other quantifiers are similar. “And/or” describes the relationship between related objects, indicating that there can be three relationships. For example, A and/or B can mean: A exists alone, A and B exist simultaneously, and B exists alone. The character “/” generally indicates that the related objects are in an “or” relationship. The singular forms “a”, “the” and “the” are intended to include the plural forms as well, unless the context clearly indicates otherwise.

It is further understood that the terms “first”, “second”, etc. are used to describe various information, but such information should not be limited to these terms. These terms are only used to distinguish information of the same type from each other and do not imply a specific order or importance. In fact, expressions such as “first” and “second” can be used interchangeably. For example, without departing from the scope of the present disclosure, the first information may also be called second information, and similarly, the second information may also be called first information.

It will be further understood that although the operations are described in a specific order in the drawings in the embodiments of the present disclosure, this should not be understood as requiring these operations to be performed in the specific order shown or in a serial order, or requiring all operations shown to be performed to obtain ae desired result. In certain circumstances, multitasking and parallel processing may be advantageous.

Other embodiments of the present disclosure will be readily apparent to those skilled in the art from consideration of the specification and practice of the invention disclosed herein. The present disclosure is intended to cover any variations, uses, or adaptations of the present disclosure that follow the general principles of the present disclosure and include common knowledge or customary technical means in the technical field that are not disclosed in the present disclosure.

It is to be understood that the present disclosure is not limited to the precise structures described above and illustrated in the accompanying drawings, and various modifications and changes may be made without departing from the scope thereof. The scope of the present disclosure is limited only by the appended rights.

1. A communication method, performed by a terminal, comprising:
monitoring an inference performance of an artificial intelligence (AI) model, in response to determining that air interface communication is performed between the terminal and a network device based on the AI model.

2. The method according to claim 1, wherein monitoring the inference performance of the AI model comprises:
monitoring the inference performance of the AI model based on an inference result of the AI model.

3. The method according to claim 2, wherein monitoring the inference performance of the AI model based on the inference result of the AI model comprises:
determining an inference object corresponding to the inference result of the AI model; and
monitoring the inference performance of the AI model based on an actual state of the inference object and the inference result of the AI model.

4. The method according to claim 1, wherein monitoring the inference performance of the AI model comprises:
intermittently monitoring the inference performance of the AI model at a time interval.

5. The method according to claim 4, wherein intermittently monitoring the inference performance of the AI model at the time interval comprises at least one of:
intermittently monitoring the inference performance of the AI model based on a preconfigured monitoring cycle;
intermittently monitoring the inference performance of the AI model at a set time interval based on a preconfigured number of times of inference; or
receiving a monitoring instruction sent by the network device at a set time interval, and intermittently monitoring the inference performance of the AI model based on the monitoring instruction.

6. (canceled)

7. The method according to claim 4, further comprising:
updating the time interval based on a communication state of the terminal.

8. The method according to claim 1, further comprising:
determining a monitoring result obtained by monitoring the inference performance of the AI model; and
sending the monitoring result to the network device.

9. The method according to claim 8, wherein sending the monitoring result to the network device comprises at least one of:
in response to determining that the monitoring result comprises more than one monitoring result, sending the more than one monitoring result to the network device respectively;
in response to determining that the monitoring result comprises more than one monitoring result, sending an inference performance result to the network device, wherein the inference performance result is obtained based on the more than one monitoring result;
in response to the monitoring result meeting a preset condition, sending the monitoring result meeting the preset condition to the network device;
cyclically sending the monitoring result to the network device based on a preconfigured inference performance reporting cycle; or
sending the monitoring result to the network device based on a reporting instruction sent by the network device.

10. The method according to claim 1, wherein an inference node of the AI model is the terminal or the network device, and a performance monitoring node of the AI model is the terminal or the network device;
in a case that the inference node of the AI model is the network device, and the performance monitoring node of the AI model is the terminal, the method further comprises receiving an inference result of the AI model sent by the network device; and
in a case that the inference node of the AI model is the terminal, and the performance monitoring node of the AI model is the network device, the method further comprises sending the inference result of the AI model to the network device.

11.-13. (canceled)

14. A communication method, performed by a network device, comprising:
monitoring an inference performance of an artificial intelligence (AI) model, in response to determining that air interface communication is performed between a terminal and the network device based on the AI model.

15. The method according to claim 14, wherein monitoring the inference performance of the AI model comprises:
monitoring the inference performance of the AI model based on an inference result of the AI model.

16. The method according to claim 15, wherein monitoring the inference performance of the AI model based on the inference result of the AI model comprises:
determining an inference object corresponding to the inference result of the AI model;
and monitoring the inference performance of the AI model based on an actual state of the inference object and the inference result of the AI model.

17. The method according to claim 14, wherein monitoring the inference performance of the AI model comprises:
intermittently monitoring the inference performance of the AI model at a time interval.

18. The method according to claim 17, wherein intermittently monitoring the inference performance of the AI model at the time interval comprises at least one of:
intermittently monitoring the inference performance of the AI model based on a preconfigured monitoring cycle; or
intermittently monitoring the inference performance of the AI model at a set time interval based on a preconfigured number of times of inference; or
wherein the method further comprises:
sending a monitoring instruction to the terminal at a set time interval, wherein the monitoring instruction is used to trigger the terminal to monitor the inference performance of the AI model.

19. (canceled)

20. The method according to claim 17, further comprising:
obtaining a communication state of the terminal; and
updating the time interval based on the communication state of the terminal.

21. The method according to claim 14, further comprising:
receiving a monitoring result sent by the terminal.

22. The method according to claim 21, wherein receiving the monitoring result sent by the terminal comprises at least one of:
receiving more than one monitoring result sent by the terminal;
receiving an inference performance result sent by the terminal, wherein the inference performance result is obtained based on more than one monitoring result;
receiving a monitoring result meeting a preset condition sent by the terminal;
cyclically receiving the monitoring result sent by the terminal based on a preconfigured inference performance reporting cycle; or
sending a reporting instruction to the terminal, and receiving the monitoring result sent by the terminal that is obtained by monitoring the inference performance of the AI model.

23. The method according to claim 14, wherein an inference node of the AI model is the network device or the terminal, and a performance monitoring node of the AI model is the network device or the terminal;
in a case that the inference node of the AI model is the terminal, and the performance monitoring node of the AI model is the network device, the method further comprises receiving an inference result of the AI model sent by the terminal; and
in a case that the inference node of the AI model is the network device, and the performance monitoring node of the AI model is the terminal, the method further comprises sending the inference result of the AI model to the terminal.

24.-28. (canceled)

29. A deviceterminal, comprising:
a processor; and
a memory for storing instructions executable by the processor;
wherein the processor is configured to:
monitor an inference performance of an artificial intelligence (AI) model, in response to determining that air interface communication is performed between the terminal and a network device based on the AI model.

30. A network device, comprising:
a processor; and
a memory for storing instructions executable by the processor;
wherein the processor is configured to perform the method according to claim 14.

31. (canceled)

32. (canceled)
